(19) United States
(12) Patent Application Publication
(10) Pub. No.: US 2008/0126347 A1
(43) Pub. Date: May 29, 2008

(54) FREQUENT PATTERN MINING SYSTEM

(75) Inventor: Kouichirou Mori, Saitama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/945,823

(22) Filed: Nov. 27, 2007

(30) Foreign Application Priority Data
Nov. 27, 2006 (JP) 2006-317942
Feb. 27, 2007 (JP) 2007-046427

(51) Int. Cl. G06F 17/30

(52) U.S. Cl. 707/6; 707/E17.039

(57) ABSTRACT

A frequent pattern mining system includes: a candidate pattern generation unit for generating a candidate record set having one record or more as an element, generating a candidate item set by extracting the items that belong commonly to respective records, and calculating a length of the candidate item set; a pattern removing unit for removing the candidate record set corresponding to the candidate item set whose pattern length is below the minimum pattern length; a frequent pattern generation unit for extracting all subsets whose pattern length is more than the minimum pattern length from the candidate item set; and the candidate record set generation unit that generates repeatedly an union of sets of two candidate record sets, in which only one element is different mutually, from the candidate record set, a number of records of which is largest, as a new candidate record set until the new candidate record set is not generated.

### RELATED APPLICATION(S)

The present disclosure relates to the subject matters contained in Japanese Patent Application No. 2006-317942 filed on Nov. 27, 2006, and in Japanese Patent Application No. 2007-046427 filed on Feb. 27, 2007, which are incorporated herein by reference in its entirety.

### FIELD

The present invention relates to a frequent pattern mining system and a method for performing frequent pattern mining for discovering frequent patterns contained in many records from among a set of records, the frequent pattern being one of elements in the records.

### BACKGROUND

A technology to discover useful knowledge from a large amount of data is called data mining. As one of data mining approaches, there has been proposed a technique called frequent pattern mining. The frequent pattern mining is to discover combinations of attributes that appear frequently in the database.

There is disclosed, in the following Related-art Document 1, an example of such method for performing frequent pattern mining that searches an attribute space (combinations of attributes). There is disclosed, in the following Related-art Document 2, a method for parallelizing the method disclosed in the Related-art Document 1.

There is disclosed in JP-A-2001-167098 a method for performing a data mining by using parallel distributed processing.

There is disclosed, in the following Related-art Document 3, an example of an algorithm for obtaining a longest common subsequence, which is the longest sequential pattern existing commonly to respective sequence contained in a candidate record set.

Related-art Document 1: R. Agrawal, et al., “Fast Algorithms for Mining Association Rules”, Proc. of Intl. Conf. On Very large Data Bases, p 487-499, 1994

Related-art Document 2: R. Agrawal, et al., “Parallel Mining of Association Rules”, IEEE transaction on Knowledge and Data Engineering, Vol. 8, Issue 6, December 1996

Related-art Document 3: L. Bergroth, et al., “A Survey of Longest Common Subsequence Algorithms”, Proc. of the 7-th Intl. Symposium on String Processing Information Retrieval, 2000

When frequent patterns are extracted from data in a situation that the number of attributes is larger than the number of records, e.g., in a situation extracting frequent patterns from a gene data, the number of attribute combinations is explosively increased. Accordingly, in such situation, there occurs a problem that computing time becomes explosively long.

### SUMMARY

According to a first aspect of the invention, there is provided a frequent pattern mining system for discovering a frequent pattern from a target data of a set of records, each of the records containing a set of items, the frequent pattern being defined as: a pattern of the set of items contained in records; a pattern including a number of the items more than a minimum pattern length; and a pattern whose support count is larger than a minimum support count. The system includes: a target data storage that stores the target data; a candidate record set generation unit that generates a candidate record set having one or more of the records contained in the target data as an element; a candidate item set generation unit that generates a candidate item set by extracting the items that belong commonly to each of the records contained in the candidate record set; a pattern length calculation unit that calculates the number of the items belonging to the candidate item set to obtain a pattern length of the candidate item set; a pattern removing unit that removes the candidate record set corresponding to the candidate item set having the pattern length shorter than the minimum pattern length; a frequent pattern generation unit that extracts all subsets, having the pattern length that is equal to or larger than the minimum pattern length, from the candidate item set, to which the candidate record set in which the number of the records is more than the minimum support count corresponds, to obtain the frequent pattern; and a frequent pattern storage that stores the frequent pattern. The candidate record set generation unit operates to: (1) generate the candidate record set containing one of the records contained in the target data as the element, when the candidate record set does not exist; and (2) generate repeatedly an union of two of the candidate record sets, in which only one of the elements is mutually different, from the candidate record set having the largest number of the records as elements, as a new candidate record set until the new candidate record set could not be generated, when the candidate record set exists.

According to a second aspect of the invention, there is provided a method for performing a frequent pattern mining for discovering frequent patterns from an target data of a set of records, each of the records containing a set of items, the frequent pattern being defined as: a pattern of the set of items contained in records; a pattern including a number of the items more than a minimum pattern length; and a pattern whose support count is larger than a minimum support count. The method includes: generating a candidate record set having one or more of the records contained in the target data as an element; generating a candidate item set by extracting the items that belong commonly to each of the records contained in the candidate record set; calculating the number of the items belonging to the candidate item set to obtain a pattern length of the candidate item set; removing the candidate record set corresponding to the candidate item set having the pattern length shorter than the minimum pattern length; and extracting all subsets, having the pattern length that is equal to or larger than the minimum pattern length, from the candidate item set, to which the candidate record set in which the number of the records is more than the minimum support count corresponds, to obtain the frequent pattern. The candidate record set is generated by performing: (1) generating the candidate record set containing one of the records contained in the target data as the element, when the candidate record set does not exist; and (2) generating repeatedly an union of two of the candidate record sets, in which only one of the elements is mutually different, from the candidate record set having a largest number of the records as elements, as a new candidate record set until the new candidate record set could not be generated, when the candidate record set exists.

According to a third aspect of the invention, there is provided a frequent pattern mining system for discovering a frequent sequential pattern from a target data of a set of sequential records, each of the sequential records containing a set of items arranged in series, the frequent sequential pattern being defined as: a pattern of the set of items contained in the sequential records and arranged in an order in the particular sequential record; a pattern including a number of the items more than a minimum pattern length; and a pattern whose support count is larger than a minimum support count. The system includes: an target data storage that stores the target data; a candidate record set generation unit that generates a candidate record set having one or more of the sequential records contained in the target data as an element; a candidate sequential pattern generation unit that generates a candidate sequential pattern by extracting a longest sequential pattern that commonly exists in each of the sequential records contained in the candidate record set; a pattern length calculation unit that calculates a number of the items belonging to the candidate sequential pattern to obtain a pattern length of the candidate sequential pattern; a pattern removing unit that removes the candidate record set corresponding to the candidate sequential pattern having the pattern length shorter than the minimum pattern length; a candidate record set storage that stores the candidate record sets that are not removed by the pattern removing unit; a subset generation unit that generates a subset having the pattern length shorter than the candidate record set with respect to the candidate record set; a subset searching unit that deletes the candidate record set when no subset generated with respect to the candidate record set is stored in the candidate record set storage; a frequent pattern generation unit that extracts all subsets, having the pattern length that is equal to or larger than the minimum pattern length, from the candidate sequential patterns, to which the candidate record set in which the number of the sequential records is more than the minimum support count corresponds, to obtain the frequent sequential pattern; and a frequent pattern storage that stores the frequent sequential pattern. The candidate record set generation unit operates to: (1) generate the candidate record set containing one of the sequential records contained in the target data as the element, when the candidate record set does not exist; and (2) generate repeatedly an union of two of the candidate record sets, in which only one of the elements is mutually different, from the candidate record set having the largest number of the sequential records as elements, as a new candidate record set until the new candidate record set could not be generated, when the candidate record set exists.

According to a fourth aspect of the invention, there is provided a method for performing a frequent pattern mining for discovering frequent sequential patterns from a target data of a set of sequential records, each of the sequential records containing a set of items arranged in series, the frequent sequential pattern being defined as: a pattern of the set of items contained in sequential records and arranged in an order in the particular sequential record; a pattern including a number of the items more than a minimum pattern length; and a pattern whose support count is larger than a minimum support count. The method includes: generating a candidate record set having one or more of the sequential records contained in the target data as an element; generating a candidate sequential pattern by extracting a longest sequential pattern that commonly exists in each of the sequential records; calculating the number of the items belonging to the candidate sequential pattern to obtain a pattern length of the candidate sequential pattern; removing the candidate record set corresponding to the candidate sequential pattern having the pattern length shorter than the minimum pattern length; storing the candidate record sets that are not removed by the pattern removing unit into a candidate record set storage; generating a subset having the pattern length shorter than the candidate record set with respect to the candidate record set; deleting the candidate record set when no subset generated with respect to the candidate record set is stored in the candidate record set storage; and extracting all subsets, having the pattern length that is equal to or larger than the minimum pattern length, from the candidate sequential patterns, to which the candidate record set in which the number of the sequential records is more than the minimum support count corresponds, to obtain the frequent sequential pattern. The candidate record set is generated by performing: (1) generating the candidate record set containing one of the sequential records contained in the target data as the element, when the candidate record set does not exist; and (2) generating repeatedly an union of two of the candidate record sets, in which only one of the elements is mutually different, from the candidate record set having a largest number of the sequential records as elements, as a new candidate record set until the new candidate record set could not be generated, when the candidate record set exists.

### BRIEF DESCRIPTION OF THE DRAWINGS

In the accompanying drawings:

FIG. 1 is a block diagram of a frequent pattern mining system according to a first embodiment of the present invention;

FIG. 2 is a table of a target data from which frequent patterns are discovered;

FIG. 3 is a table of a target data from which frequent patterns are discovered;

FIG. 4 is a flowchart of a method for performing a frequent pattern mining according to the first embodiment;

FIG. 5 is a view showing an example of a tree structure of data in the method for performing a frequent pattern mining according to the first embodiment;

FIG. 6 is a block diagram of a frequent pattern mining system according to a second embodiment of the present invention;

FIG. 7 is a block diagram of a calculation unit in the frequent pattern mining system according to the second embodiment;

FIG. 8 is a flowchart of a method for performing a frequent pattern mining according to the second embodiment;

FIG. 9 is a view showing an example of an target data splitting method used in the method for performing a frequent pattern mining according to the second embodiment;

FIG. 10 is a view showing an example of a tree structure of split data in the method for performing a frequent pattern mining according to the second embodiment;

FIG. 11 is a view showing another example of the tree structure of split data in the method for performing a frequent pattern mining according to the second embodiment;

FIG. 12 is a block diagram of a frequent pattern mining system according to a third embodiment of the present invention;

FIG. 13 is a table of a target data from which frequent patterns are discovered;

FIG. 14 is a flowchart of the method for performing a frequent pattern mining according to the third embodiment of the present invention; and

FIG. 15 is a view showing an example of a tree structure of data in the method for performing a frequent pattern mining according to the third embodiment.

### DETAILED DESCRIPTION OF THE EMBODIMENTS

Referring now to the accompanying drawings, embodiments of the present invention will be described in detail. In the following description, same reference symbols are affixed to the same or similar units and configurations for omitting their redundant explanation.

### First Embodiment

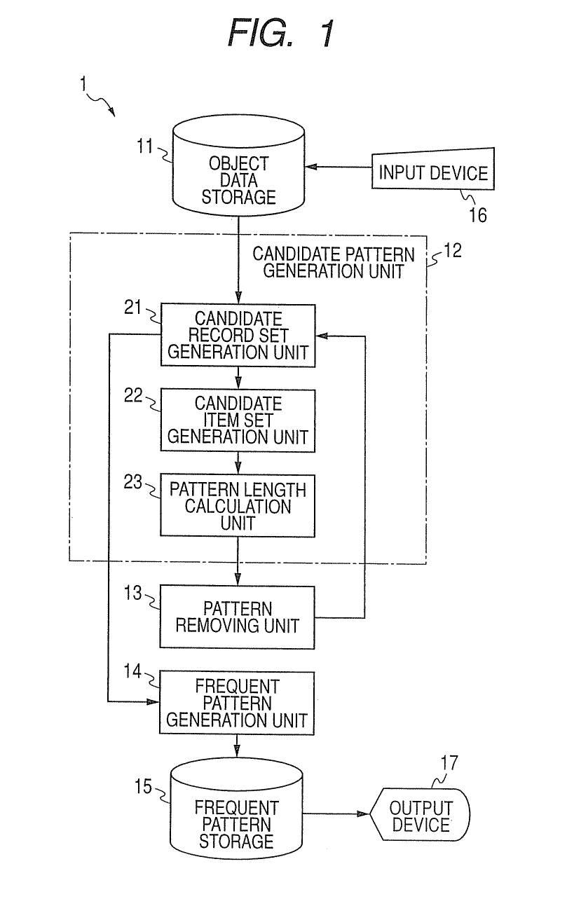

FIG. 1 is a block diagram of a frequent pattern mining system according to a first embodiment of the present invention.

A frequent pattern mining system 1 includes a target data storage 11, a candidate pattern generation unit 12, a pattern removing unit 13, a frequent pattern generation unit 14, a frequent pattern storage 15, an input device 16 and an output device 17.

Target data from which frequent patterns are discovered is input from the input device 16 and stored in the target data storage 11. The input device 16 is an interface for receiving the target data, for example, from other computers that collect the target data.

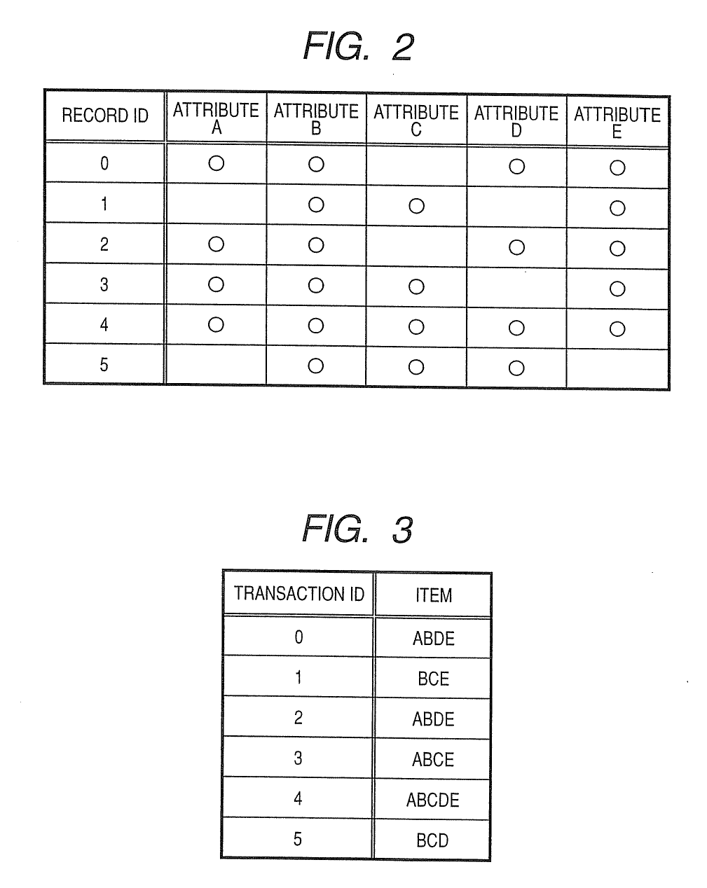

FIG. 2 and FIG. 3 are examples of target data from which frequent patterns are discovered.

The target data shown in FIG. 2 is an example in a relational database format. The relational database is configured by combinations of a record ID, and attributes. In the example shown in FIG. 2, the attribute is binary data, and the case where the record specified by the record ID has the attribute is represented by a circle and the case where the record does not have the attribute is represented by a blank.

Here, in addition to the binary attribute itself, the multi-valued attribute or the continuous value attribute may be converted into the binary attribute. For example, assume that the multi-valued attribute such as a blood pressure is present in the medical diagnostic database and takes three values such as high, normal, and low values. In this case, this attribute can be converted into three binary attributes of a first blood pressure (high), a second blood pressure (normal), and a third blood pressure (low). Also, the continuous value attribute such as a height can be converted into the binary attribute when the height is converted into discrete values such as a first height (below 150 cm), a second height (more than 150 cm but below 170 cm), and a third height (more than 170 cm).

The target data shown in FIG. 3 is an example in a transaction database format, and is converted from the data in the relational database format shown in FIG. 2. The data in any relational database format can be converted into the data in the transaction database format. The transaction database format is obtained by extracting the attributes that respective records in the relational database format have and listing the attribute names. In some cases, the record is called “transaction” and the attribute is called “item”.

The data in the transaction database format is a set of the transactions specified by a transaction ID. Each transaction is a set of items.

In the following description, the term “record” and the term “transaction” are used to have the same meaning. Also, the term “attribute” and the term “item” are used to have the same meaning. It is also assumed that a set of records is represented by an arrangement of the record IDs. For example, a set having the records whose record IDs are 0 and 1 as elements is represented by “01”. Similarly, it is assumed that a set of items is represented by an arrangement of the items. For example, a set of items having B, C, E as elements is represented by “BCE”.

The “frequent patterns” are all patterns contained in the target data and having a support count equal to or larger than a minimum support count. The “pattern” is a combination of items contained in a certain transaction, i.e., a subset of the item set constituting a certain transaction. The “support count” is the number of transactions in which that pattern is contained. The “minimum support count” is the minimum support count that is decided to be “frequently appearing” in the target data.

When the number of items (the number of attributes) is large, it is described that “data is high-dimensional”. In the present embodiment, such a situation is assumed that the number of attributes is extremely large (in order of thousands to tens of thousands). The frequent pattern mining system according to the first embodiment may be configured to perform the frequent pattern mining for any data, but it is assumed in the following description that the frequent pattern mining is performed for a medical diagnostic database.

The candidate pattern generation unit 12 is provided with: a candidate record set generation unit 21; a candidate item set generation unit 22; and a pattern length calculation unit 23.

The candidate record set generation unit 21 generates a candidate record set having one record or more contained in the target data as elements. The candidate item set generation unit 22 extracts the items belonging commonly to respective records contained in the candidate record set, and generates a candidate item set corresponding to the candidate record set. The pattern length calculation unit 23 calculates a pattern length of the candidate item set. The “pattern length” is the number of items belonging to a certain item set.

The pattern removing unit 13 removes the candidate record set, whose pattern length of the candidate item set corresponding to the candidate record set is below a minimum pattern length, from the candidate record set.

The frequent pattern generation unit 14 extracts all subsets having the minimum pattern length or more from the candidate item set corresponding to the candidate record set that contains the number of records in excess of the minimum support count, and set them as the frequent patterns.

The extracted frequent patterns are transferred from the frequent pattern generation unit 14 to the frequent pattern storage 15. Also, the frequent pattern storage 15 transfers the frequent patterns to the output device 17. The output device 17 displays the frequent patterns on a display screen or transmits the frequent patterns to other computer, for example.

Next, a method for performing the frequent pattern mining according to the first embodiment will be explained.

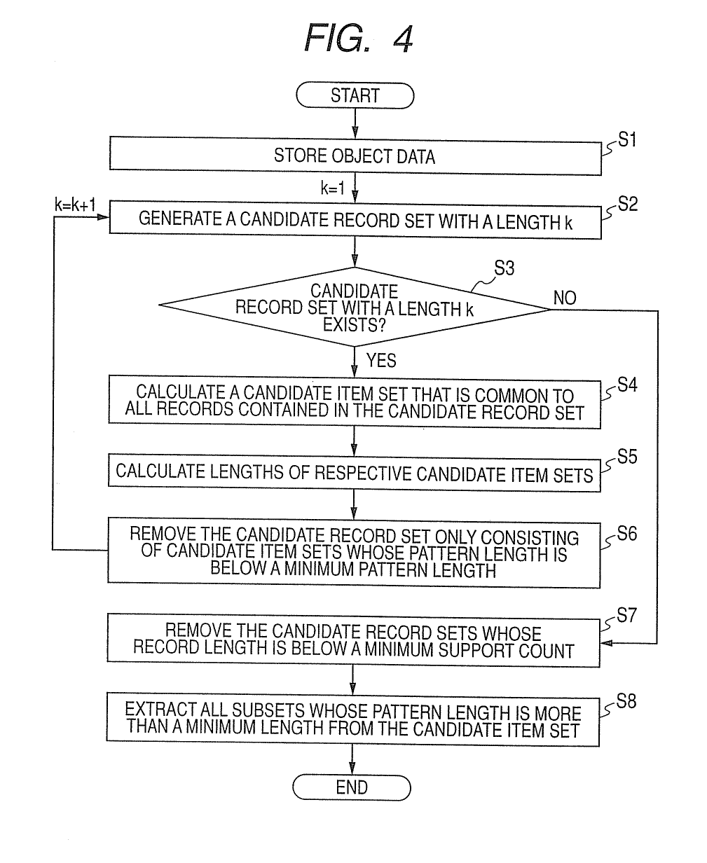

FIG. 4 is a flowchart of a method for performing a frequent pattern mining according to the first embodiment.

First, the target data is input from the input device 16 and stored in the target data storage 11 (step S1). A number of repetitions “k” is set to 1.

The candidate record set generation unit 21 generates the candidate record set with a length of “k” (step S2). A length of the candidate record set is the number of records contained in this candidate record set.

When performing a first repetition (path), i.e. when k=1, the candidate record set with a length 1 is generated. The set containing respective records contained in the target data one by one can be set as the candidate record set with a length 1. Accordingly, the candidate record set is generated as many as a total number of records contained in the target data.

In the k-th path, the candidate record set generation unit 21 generates the candidate record set whose record length is k from the candidate record set whose record length is k−1. When rA and rB give the candidate record set with a length k−1 and satisfy Formula (1), the record set with a length k is generated by Formula (2).

(rA[1]=rB[1])̂(rA[2]=rB[2])̂ . . . ̂(rA[k−2]=rB[k−2])̂(rA[k−1]<rB[k−1]) (1)

rA[1]rA[2]rA[k−2]rA[k−1]rB[k−1] (2)

In the above-shown Formula (1) and Formula (2), the symbol “<” denotes an order of dictionary, and rA[i], rB[i] denote the i-th record of rA, rB respectively.

Then, the candidate record set generation unit 21 determines whether or not the candidate record set with a length k is present (step S3). If the candidate record set with a length k is present, the processes in step S4 to step S6 are executed. If the candidate record set with a length k is not present, the processes in step S7 and step S8 are executed. In this manner, the processes in step S3 to step S6 are repeated while increasing k by 1 until the candidate record set with a length k becomes an empty set.

In step S4, the candidate item set generation unit 22 generates the candidate item set as a set of the items that are common to all records contained in the candidate record set with a length k. For example, when a certain candidate record sets are composed of rA and rB and the candidate item set contained in these candidate record sets are IA, IB respectively, IA∩IB as a set of items that are common to the candidate record sets rArB is generated.

In step S5, the pattern length calculation unit 23 calculates pattern lengths of respective candidate item sets corresponding to respective candidate record sets with a length k.

In step S6, the pattern removing unit 13 removes the candidate record set corresponding to the candidate item sets whose length is below the minimum pattern length.

In step S7, the frequent pattern generation unit 14 removes the candidate record sets whose record length is below the minimum support count from all candidate record sets that were not removed by the pattern removing unit 13.

In step S8, the frequent pattern generation unit 14 extracts all subsets, whose length is more than the minimum length, of the candidate item set corresponding to all remaining candidate record sets F′. Here, the extracted sets F become the frequent patterns.

Next, a flow of discovering the frequent patterns from the target data shown in FIG. 2 and FIG. 3 in the first embodiment when the minimum pattern length is set to 3 and the minimum support count is set to 3 will be explained.

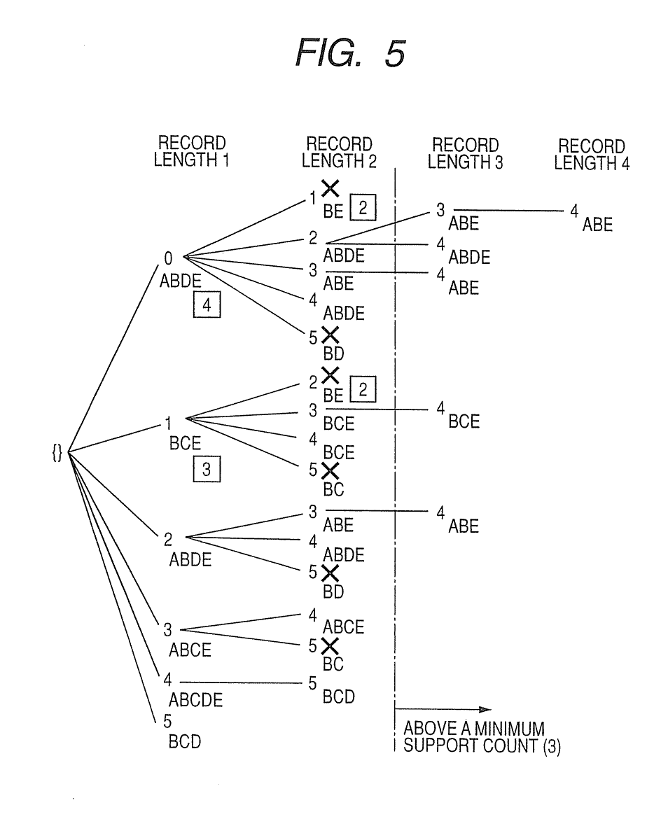

FIG. 5 is a view showing an example of a tree structure of data in the method for performing a frequent pattern mining according to the first embodiment of the present invention. The tree is constructed by nodes and branches. In FIG. 5, respective numeric characters connected by a straight line (branch) are nodes indicating the record ID. Also, sets of all record IDs connected by a straight line on the left side of the record ID show the candidate record sets. The alphabet denotes the item, and the candidate item set corresponding to the candidate record set is given near the record ID shown on the rightmost side of the candidate record set. The numeric character surrounded by a square denotes the pattern length.

The target data shown in FIG. 2 and FIG. 3 is stored in the target data storage 11 (step S1). Then, in the first path (K=1), six sets 0, 1, 2, 3, 4, 5 as the candidate record set with a length 1 are generated (step S2). If the candidate record set with a length 1 is present (step S3) the candidate item sets ABDE, BCE, ABDE, ABCE, ABCDE, BCD that are contained in respective candidate record sets are calculated (step S4). Also, pattern lengths of respective candidate item sets are calculated (step S5). In this case, because the candidate record set whose pattern length is below the minimum pattern length (3) is not present, the candidate record set that is to be removed in step S6 is not present.

In the second path (k=2), the candidate record set with a length 2 is generated from the candidate record set with a length 1 (step S2). For example, because two candidate record sets of 0 and 1 satisfy a relation given by Formula (1), the candidate record set of 01 is generated by Formula (2). Similarly, fourteen sets of 01, 02, 03, . . . , 45 as the candidate record set with a length 2 respectively are generated by combining other candidate record sets with a length 1 mutually.

If the candidate record set with a length k is present (step S3), the candidate item sets are calculated (step S4). For example, the item set contained in the candidate record set of 0 is ABDE, and the item set contained in 1 is BE. Therefore, the candidate item set corresponding to the candidate record set of 01 is BE that is a set of items common to ABDE and BE.

Then, a length of the item set corresponding to the candidate record set with a length 2 is calculated (step S5). For example, the candidate item set corresponding to the candidate record set of 01 is BE, and a length of the candidate item set is 2.

After the lengths of the candidate item sets in all candidate record sets are calculated, the candidate record set whose pattern length is below a minimum pattern length (3) is removed (step S6). Here, the candidate record sets of 01, 05, 12, 15, 25, 35, in which the length of the candidate item set is below 3, are removed. Therefore, nine candidate record sets of 02, 03, 04, 13, 14, 23, 24, 34, 45 among the candidate record sets with a length 2 remain.

In the third path (k=3), the candidate record set with a length 3 is generated from the candidate record set with a length 2 (step S2). In this example, five candidate record sets of 023, 024, 034, 134, 234 are generated.

If the candidate record set with a length 3 is present (step S3), the candidate item set is calculated (step S4), and the length of the candidate item set is calculated (step S5). Because the lengths of all candidate item sets are above the minimum record length (3), there is no candidate record set that is to be removed (step S6).

In the fourth path (k=4), the candidate record set with a length 4 is generated from the candidate record set with a length 3 (step S2). In this example, one candidate record set of 0234 is generated.

If the candidate record set with a length 4 is present (step S3), the candidate item set is calculated (step S4), and the length of the candidate item set is calculated (step S5). Because the lengths of all candidate record sets are above the minimum record length (3), there is no candidate record set that is to be removed (step S6).

In the fifth path (k=5), the candidate record set with a length 5 is generated from the candidate record set with a length 4 (step S2). In this example, the candidate record set to be generated is not present. Therefore, the processes in step S7 and step S8 are executed.

Here, because the minimum support count is set to 3, the candidate record sets whose record length is below 3, i.e., whose record length is 1 or 2 are removed (step S7) There remain six candidate record sets of 023, 024, 034, 134, 234, 0234.

The candidate item sets corresponding to these candidate record sets are ABE, ABDE, ABE, BCE, ABE respectively, and a set of these candidate item sets is F′. Out of them, only two subsets ABE, BCE themselves exist in ABE, BCE as the subset whose minimum pattern length is above 3. In contrast, five subsets ABD, ABE, ADE, BDE, ABDE exist in ABDE as the subset whose minimum pattern length is above 3.

Therefore, when all subsets, whose length is more than a minimum pattern length, of these candidate item sets are extracted, F={ABD, ABE, ADE, BCE, BDE, ABDE} can be obtained as the set F of the frequent patterns.

In this manner, in the frequent pattern discovering procedures in the present embodiment, not the searching of the attribute space (a combination of the attributes) but the searching of the record space (a combination of the records) is executed. Therefore, even when the number of attributes is increased, an explosive increase of the number of attribute combinations is never caused. As a result, the frequent patterns can be found effectively from the data having the large number of attributes.

Also, the candidate item sets and the candidate record sets corresponding to these candidate item sets are trimmed by using the minimum pattern length as a minimum length of the frequent pattern. Therefore, an amount of necessary operations can be reduced, and thus the process of discovering the frequent pattern can be executed effectively.

### Second Embodiment

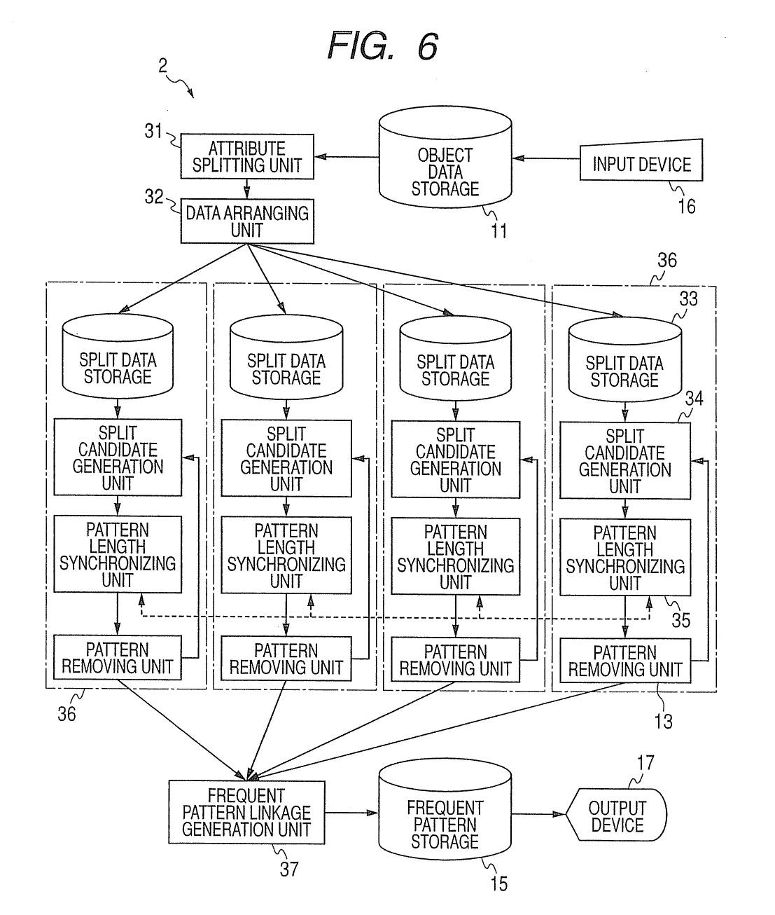

FIG. 6 is a block diagram of a frequent pattern mining system according to a second embodiment of the present invention.

The frequent pattern mining system according to the second embodiment is configured in such a manner that a part of the frequent pattern mining system in the first embodiment is constructed by the distributed memory type parallel computer to execute a part of process in parallel.

A frequent pattern mining system 2 includes the target data storage 11, an attribute splitting unit 31, a data arranging unit 32, a plurality of calculation units 36, a frequent pattern linkage generation unit 37, the frequent pattern storage 15, the input device 16, and the output device 17. In FIG. 6, the number of calculation units 36 is set to four, but this number can be increased or decreased appropriately. Each calculation unit 36 constitutes a computer unit of the distributed memory type parallel computer, for example.

The attribute splitting unit 31 splits the target data stored in the target data storage 11 in the attribute direction. The phrase “split in the attribute direction” means to split the attributes contained in the target data into a plurality of groups and then generate split data that is composed of the record ID and the attribute data corresponding to the split attribute group.

The data arranging unit 32 transfers respective split data to respective calculation units 36.

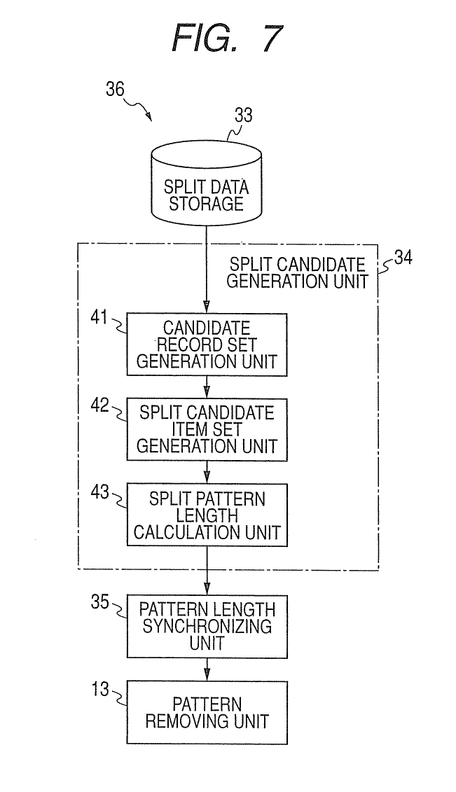

FIG. 7 is a block diagram of the calculation unit in the frequent pattern mining system according to the second embodiment.

Each calculation unit 36 has a split data storage 33, a split candidate generation unit 34, a pattern length synchronizing unit 35, and the pattern removing unit 13. The split data transferred from the data arranging unit 32 is stored in the split data storage 33.

The split candidate generation unit 34 has a candidate record set generation unit 41, a split candidate item set generation unit 42, and a split pattern length calculation unit 43. The split candidate generation unit 34 applies the process similar to that in the candidate pattern generation unit 12 (see FIG. 1) of the first embodiment to the split data allocated respectively.

The pattern length synchronizing unit 35 transfers a pattern length of the split data calculated by each calculation unit 36 to all remaining pattern length synchronizing units 35. Each pattern length synchronizing unit 35 synchronizes the pattern with a total sum of the pattern lengths of the split data calculated by all calculation units 36, and calculates the length of the candidate item set corresponding to the candidate record set.

The pattern removing unit 13 removes the candidate record set corresponding to the candidate item set whose length is below a minimum pattern length out of the candidate record set, by using the pattern length that is synchronized by the pattern length synchronizing unit 35.

The frequent pattern linkage generation unit 37 generates the candidate item set by linking the split candidate item sets of the split data that respective calculation units 36, and generates the frequent patterns by using this candidate item set.

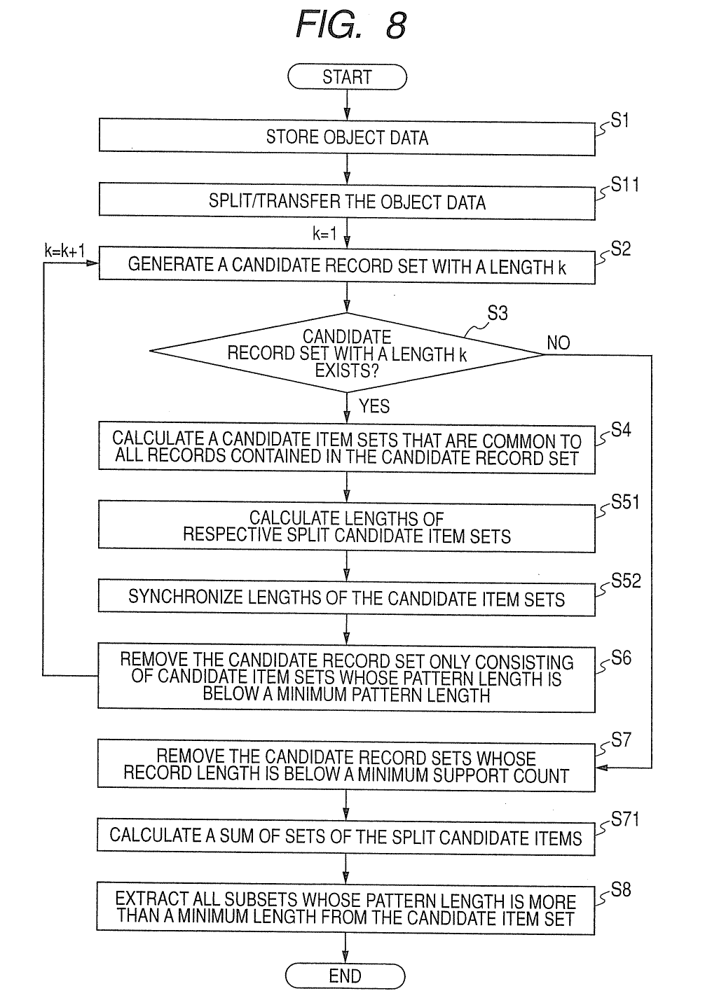

FIG. 8 is a flowchart of a method for performing a frequent pattern mining according to the second embodiment.

First, the target data is stored in the target data storage 11 (step S1). Then, the target data stored in the target data storage 11 is split by the attribute splitting unit 31 every one attribute or more (step S11). The split target data is transferred to respective calculation units 36 by the data arranging unit 32, and is stored in the split data storage 33 as the split target data (step S11).

Respective calculation units 36 apply the processes in step S2, step S3, step S4, step S51, step S52, and step S6 to respective split target data in parallel.

Next, a method of generating the split candidate item set executed by each calculation unit 36 will be explained.

First, the number of repetitions “k” is set to 1.

The candidate record set generation unit 41 generates the candidate record set with a length k (step S2). In this case, all candidate record sets that the candidate record set generation unit 41 generates are totally identical.

The candidate record set generation unit 41 determines whether or not the candidate record set with a length k is an empty set (step S3). If the candidate record set with a length k is not the empty set, the processes in step S4, step S51, step S52, and step S6 are executed. In contrast, if the candidate record set with a length k is the empty set, the processes in step S71, step S7, and step S8 are executed. In this manner, the processes in step S4, step S51, step S52, and step S6 are repeated until the candidate record set with a length k becomes the empty set.

In step S4, a set of items that are common to the candidate record sets with a length k is calculated. In the second embodiment, the split candidate item set generation unit 42 generates a set of items contained in the split data allocated respectively and stored in the split data storages 33. A set of items will be called a split candidate item set hereunder. A set obtained by linking all split candidate item sets every corresponding candidate record set corresponds to the candidate item set in the first embodiment. Therefore, all split candidate item set generation units, when assembled into one generation unit, corresponds to the candidate item set generation unit 22 in the first embodiment (see FIG. 1).

In step S51, respective split pattern length calculation units 43 calculate the pattern length of the split candidate item set corresponding to the candidate record set with a length k, and transfers the pattern length to the pattern length synchronizing unit 35.

In step S52, respective pattern length synchronizing units 35 takes synchronization between the pattern lengths of the candidate item sets by transferring the pattern length mutually among these synchronizing units 35. That is, respective pattern length synchronizing units 35 transfer the pattern lengths of the split candidate item sets that respective split pattern length calculation units 43 calculate to other pattern length synchronizing units 35. Then, the pattern length synchronizing unit 35 calculates the pattern length of the candidate item sets corresponding to respective candidate record sets by calculating a total sum of the pattern lengths of all split candidate item sets. Therefore, all pattern length synchronizing units 35 have the identical value as the pattern length of the candidate item set corresponding to respective candidate record sets. As a result, all split pattern length calculation units 43 and all pattern length synchronizing units 35, when assembled into one portion, correspond to the pattern length calculation unit 23 (see FIG. 1) in the first embodiment.

In this case, all the split candidate generation units 34 generate the same candidate record set. Therefore, arrangement of the candidate record sets can be set in respective split candidate generation units 34 in the same format. Then, in step S52, the synchronization between the pattern lengths of the candidate item sets can be taken by transferring only the arrangement of the pattern length of the split candidate item set mutually.

In step S6, the pattern removing unit 13 deletes the candidate record set corresponding to the candidate item sets whose length is below a minimum pattern length. The value that is synchronized in step S52 is employed as the pattern length of the candidate item set used herein.

In step S7, the frequent pattern linkage generation unit 37 removes the candidate record sets whose record length is below a minimum support count from the candidate record sets. In step S71, the frequent pattern linkage generation unit 37 generates the candidate item set by calculating a sum of sets of the split candidate item sets corresponding to all candidate record sets being not removed by the pattern removing unit 13.

In step S8, the frequent pattern linkage generation unit 37 extracts all subsets, whose length is more than a minimum pattern length, of the candidate item set, of the candidate item sets corresponding to all remaining candidate record set F′. The set F extracted herein gives the frequent patterns.

Next, a flow of discovering the frequent pattern from the target data same as that used in the first embodiment in the present embodiment will be explained hereunder. Here, the case where the target data is split into two parts will be explained, but the case where the target data is split into three parts will be explained similarly.

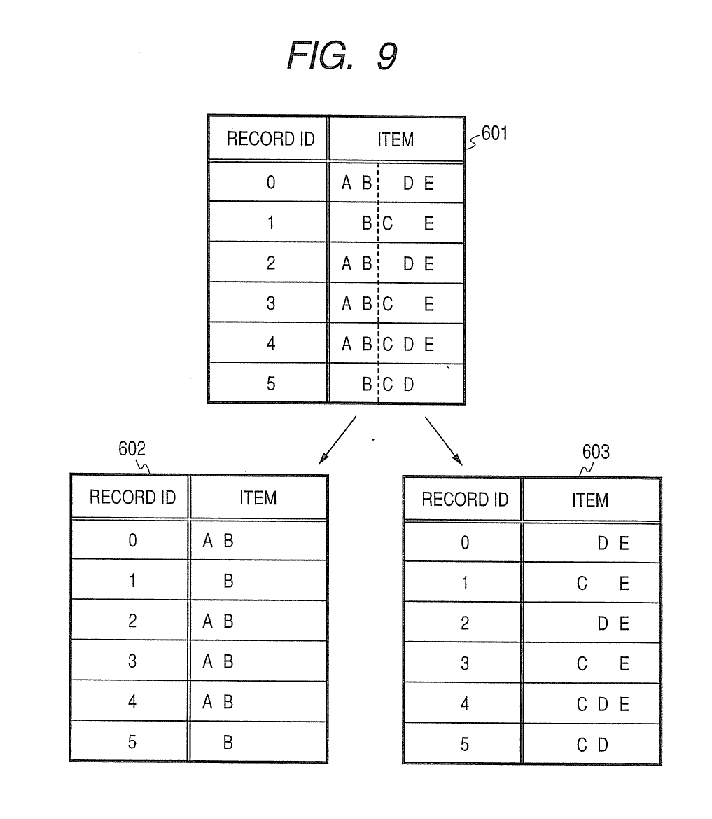

FIG. 9 is a view showing an example of the target data splitting method in the second embodiment.

The target data 601 same as in the first embodiment is split every item (attribute) to give two split target data 602, 603 (step S11), and stored in the split data storage 33. In the following explanation, the data indicated by a reference 602 is called the first split data, and the data indicated by a reference 603 is called the second split data. Also, the calculation unit 36 having the split data storage 33 in which the first split data is stored is called a first calculation unit, and the calculation unit 36 having the split data storage 33 in which the second split data is stored is called a second calculation unit.

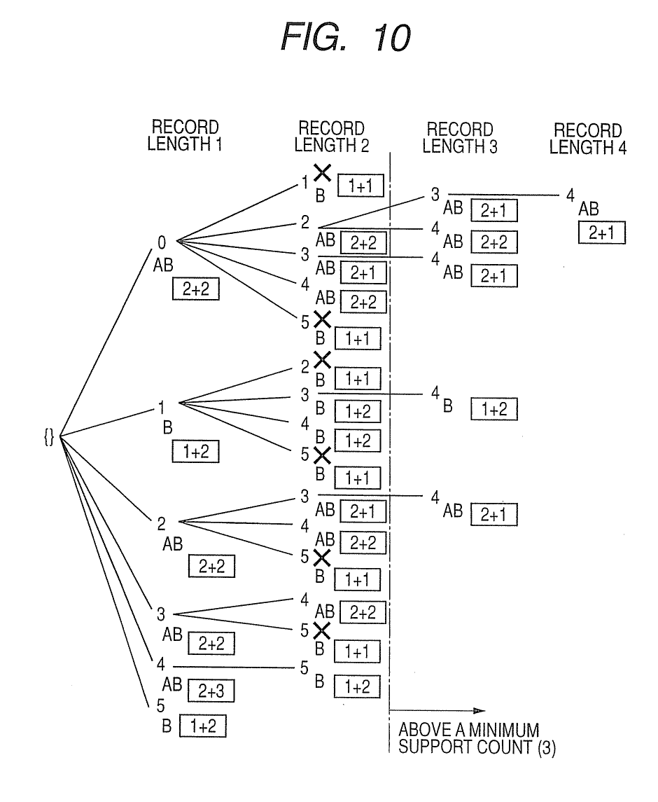

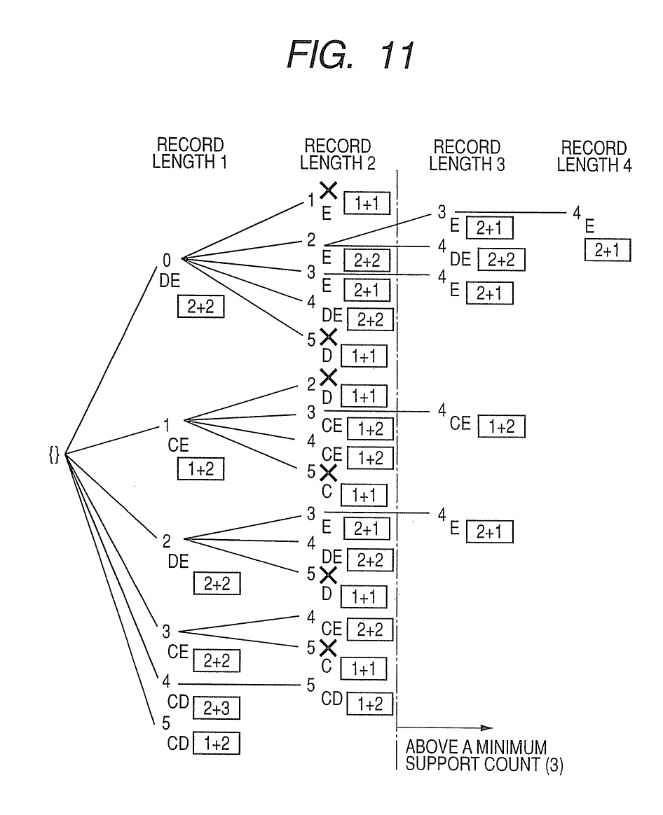

FIG. 10 and FIG. 11 are views showing an example of a tree structure of split data in the method for performing a frequent pattern mining according to the present embodiment respectively. FIG. 10 shows first split data, and FIG. 11 shows second split data.

In the first path (k=1), six sets of 0, 1, 2, 3, 4, 5 as the candidate record set with a length 1 are generated by respective candidate record set generation units (step S2). If the candidate record set with a length 1 is present (step S3), the candidate item sets contained in respective candidate record sets are calculated (step S4).

Here, the candidate item set is not present in the identical calculation unit 36, and is distributed and exists the first calculation unit 36 and the second calculation unit 36. For example, the candidate item set ABDE corresponding to the candidate record set of 0 is a sum of sets of the split candidate item set AB existing in the first calculation unit and the split candidate item set DE existing in the second calculation unit. Also, respective lengths of 2 and 2 of these split candidate item sets are calculated by the split pattern length calculation units 43 as the first calculation unit and the second calculation unit respectively.

Also, respective split pattern length calculation units 43 calculate the lengths of the split candidate item sets respectively (step S51). For example, the lengths 2 and 2 of respective split candidate item sets, i.e., split candidate item set AB corresponding to the candidate record set of 0 and the split candidate item set DE are calculated by the split pattern length calculation units 43 as the first calculation unit and the second calculation unit.

The lengths of the split candidate item sets calculated by respective split pattern length calculation units 43 are transferred mutually in step S1, and the synchronization between the pattern lengths of the candidate item sets is established. For example, the lengths 2 and 2 of the split candidate item set AB corresponding to the candidate record set of 0 and the split candidate item set DE are transferred mutually between the split pattern length calculation units 43 as the first calculation unit and the second calculation unit. Accordingly, respective pattern length synchronizing units 35 can calculate the pattern length of ABDE corresponding to the candidate record set of 0 like 2+2.

In the second path (k=2), the candidate record set with a length 2 is generated from the candidate record set with a length 1 (step S2). For example, because two candidate record sets of 0 and 1 are different in the first (=k−1) record but satisfy the relation given by Formula (1), the candidate record set of 01 is generated by Formula (2). Similarly, fourteen sets 01, 02, 03, 04, . . . , 45 as the candidate record set with a length 2 are generated respectively by combining other candidate record sets with a length 1.

If the candidate record set with a length 2 is present (step S3), the candidate item set is calculated (step S4)

The candidate item set corresponding to these candidate record sets is the item set that is common to the item sets belonging to individual records contained in the candidate record set 504. For example, the item set contained in the candidate record set of 0 is ABDE, and the item set contained in the candidate record set of 1 is BE. Therefore, the candidate item set corresponding to the candidate record set of 01 is the item set BE that is common to ABDE and BE.

Then, the length of the item set corresponding to the candidate record set with a length 2 is calculated (step S51). For example, the candidate item set corresponding to the candidate record set of 01 is BE, and the length is 2.

Similarly, the above processes are repeated while increasing the number of repetitions k until the candidate record set with a length k is not present. In the fifth path (k=5), the candidate record set with a length 5 is generated from the candidate record set with a length 4 (step S2). In this example, the candidate record set to be generated is not present.

In this example, because the minimum support count is set to 3, the candidate record sets whose record length is below 3, i.e., whose record length is 1 or 2 are removed (step S7). Remaining remain six candidate record sets are six sets 023, 024, 034, 134, 234, 0234.

Then, a sum of sets of the split candidate item sets corresponding to these candidate record sets respectively are calculated (step S71). For example, since the split candidate item sets corresponding to the candidate record set of 023 are AB and E, ABE as the sum of sets constitutes the candidate item set. Similarly, the set F′ of the candidate item sets of ABE, ABDE, ABE, BCE, ABE, ABE can be obtained like the first embodiment. Also, like the first embodiment, the set F={ABD, ABE, ADE, BCE, BDE, ABDE} of the frequent pattern can be obtained by extracting all subsets whose pattern length is more than the minimum pattern length from these candidate item sets.

In this manner, in the mining process of the frequent pattern of the present embodiment, the attribute space can be split and allocated to respective calculation units. Therefore, respective calculation units can search the record space in parallel, and thus the processing can be sped up. Also, the lengths of the candidate item sets must be synchronized. In this case, since it is the length that must be communicated between the calculation units, only a small amount of communication is required.

### Third Embodiment

FIG. 13 is an example of data as a target from which the frequent patterns are found, in a frequent pattern mining system according to the third embodiment of the present invention.

In the third embodiment, all sequential patterns having the support count that is in excess of a minimum support count are found from the sequential data as the target.

The “sequential data” is a set of the sequential records. The “sequential record” is a set in which the items are aligned in sequence. Also, the “sequential pattern” is a set in which the items belonging to a certain sequential record are aligned in accordance with the sequence in the sequential record.

That is, the sequential data is one type of sets of records (transactions) as a set of items (attributes), and the sequence of the arrangement of the attributes constituting the records is considered. The sequential record is the record in which the attributes are aligned in order like the time sequential data. Even though the sequential record has the same attributes, such sequential record is treated as the different sequential record if the sequence of respective attributes is different. The sequential record is specified by the sequence ID. For example, the sequence “ACDBE” whose sequence ID in FIG. 13 is 1 and the sequence “ADCBE” whose sequence ID is 2 are two sequences constructed by the same attributes, but such sequences are treated as the different sequences because their order of the attributes is different.

Also, the sequential pattern is given by extracting the attributes from the sequence while keeping the sequence of the arrangement in the series. For example, the sequential patterns such as “ABE”, “ACBE”, “ADBE”, and the like are contained in both the sequence whose sequence ID in FIG. 13 is 1 and the sequence whose sequence ID is 2. Out of the sequence patterns, all patterns having the support count that is in excess of a minimum support count are called the frequent sequence pattern.

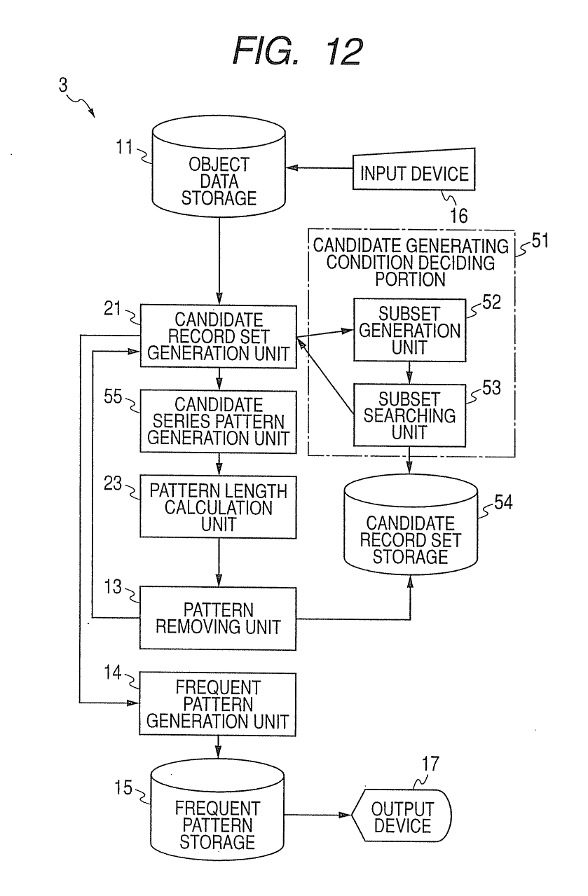

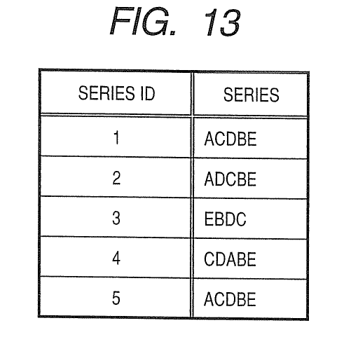

FIG. 12 is a block diagram of a frequent pattern mining system according to the third embodiment.

In a frequent pattern mining system 3, a candidate sequence pattern generation unit 55 is provided instead of the candidate item set generation unit 22 in the frequent pattern mining system (see FIG. 1) in the first embodiment, and a candidate generating condition deciding portion 51 and a candidate record set storage 54 are added. The candidate generating condition deciding portion 51 has a subset generation unit 52 and a subset searching unit 53.

The candidate record set generation unit 21 generates the candidate record set that has one sequence or more contained in the target sequential data as the element. The generated candidate record set is transferred to the subset generation unit 52 in the candidate generating condition deciding portion 51.

The subset generation unit 52 generates the subset whose length is shorter than the candidate record set by 1 from the candidate record set that the candidate record set generation unit 21 generates. The subset searching unit 53 searches whether or not the subset is stored in the candidate record set storage 54. If no subset is stored in the candidate record set storage 54, the subset searching unit 53 removes the candidate record set corresponding to the subset.

The candidate sequential pattern generation unit 55 extracts the longest sequential pattern existing commonly to respective sequence contained in the candidate record set (longest common subsequence) and generates the candidate sequential pattern corresponding to the candidate record set. When there are two longest common subsequences or more, the sequential patterns are extracted from all combinations. The pattern length calculation unit 23 calculates the pattern length of the candidate sequential pattern. The method disclosed in Non-Patent Literature 3, for example, is used in calculating the longest common subsequence.

The pattern removing unit 13 removes the candidate record set, to which the candidate sequential pattern whose pattern length is below the minimum pattern length corresponds, from the candidate record sets. Also, the pattern removing unit 13 stores the candidate record set that was not removed in the candidate record set storage 54. As a data structure of the candidate record set storage 54, for example, a Hash tree, a Trie, or the like is utilized. Also, other data structures may be utilized.

The frequent pattern generation unit 14 extracts all subsets whose pattern length is more than the minimum pattern length from the candidate sequential pattern, in which the number of sequential records contained in the corresponding candidate record set is larger than the minimum support count, as the frequent sequential pattern.

The extracted frequent sequential patterns are transferred from the frequent pattern generation unit 14 to the frequent pattern storage 15. Also, the frequent pattern storage 15 transfers the frequent sequential patterns to the output device 17. The output device 17 displays the frequent sequential patterns on the display or transmits the frequent sequential patterns to other computer, for example.

Next, a method for performing a frequent pattern mining according to the third embodiment will be explained.

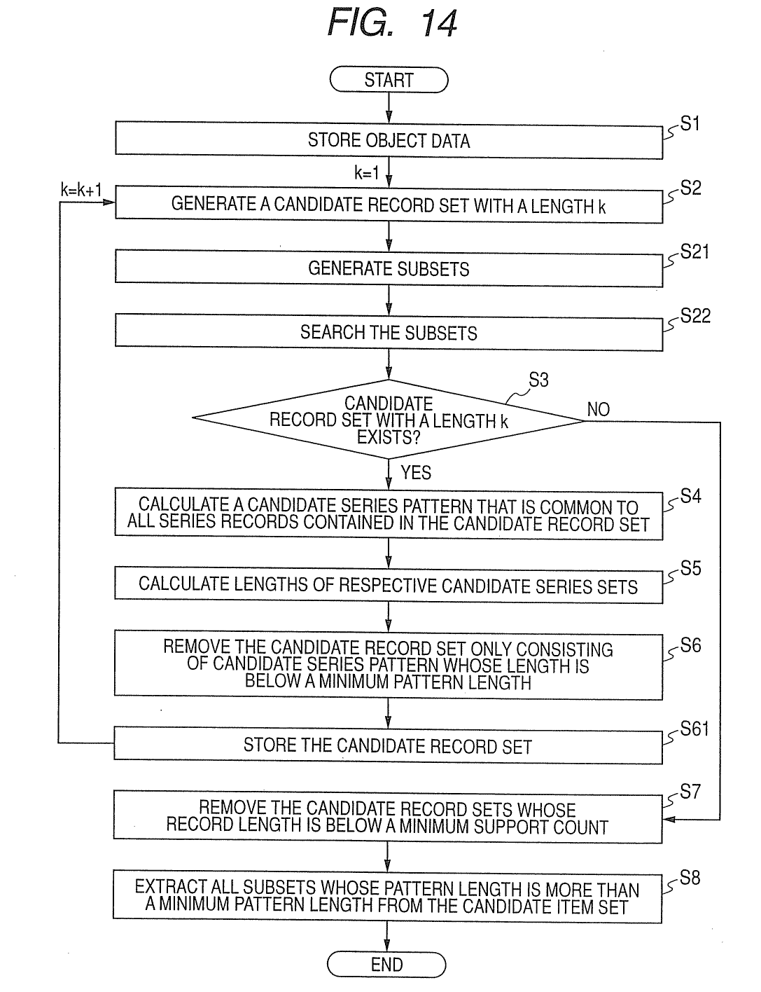

FIG. 14 is a flowchart of the method for performing a frequent pattern mining according to the third embodiment.

First, the target data is input from the input device 16 and stored in the target data storage 11 (step S1). Also, the number of repetitions “k” is set to 1.

Then, the candidate record set generation unit 21 generates the candidate record set with a length k (step S2). In the case of the first repetition (path), the candidate record set with a length 1 is generated. In the k-th path, the candidate record set generation unit 21 generates the candidate record set with a record length k from the candidate record set with a record length k−1.

Then, the subset generation unit 52 generates the subset whose record length is shorter than the candidate record set by 1 with respect to the candidate record sets respectively (step S21). The subset searching unit 53 searches whether or not the subset is stored in the candidate record set storage 54. If no subset is stored in the candidate record set storage 54, the subset searching unit 53 removes the candidate record set corresponding to the subset (step S22).

Then, the candidate record set generation unit 21 determines whether or not the candidate record set with a length k is present (step S3). If the candidate record set with a length k is present, the processes in step S41, step S5, step S6, and step S61 are executed. In contrast, if the candidate record set with a length k is not present, the processes in step S7 and step S8 are executed. In this manner, the processes in step S3, step S41, step S5, step S6 and step S61 are repeated while increasing k by 1 until the candidate record set with a length k becomes the empty set.

In step S4, the candidate sequential pattern generation unit 55 extracts the longest sequential pattern from the sequential patterns that exist commonly in all records contained in the candidate record set with a length k, and generates the candidate sequential pattern.

In step S5, the pattern length calculation unit 23 calculates the pattern lengths of respective candidate sequential patterns corresponding to respective candidate record sets with a length k.

In step S6, the pattern removing unit 13 deletes the candidate record set corresponding to the sequential pattern whose length is below the minimum pattern length.

In step S61, the pattern removing unit 13 stores the remaining candidate record sets in the candidate record set storage.

In step S7, the frequent pattern generation unit 14 removes the candidate record sets whose record length is below the minimum support count from all candidate record sets that are not removed by the pattern removing unit 13.

In step S8, the frequent pattern generation unit 14 extracts all subsets whose pattern length is longer than the minimum pattern length from the candidate sequential pattern corresponding to all remaining candidate record sets. Here, the extracted set gives the frequent sequential pattern.

Next, a flow of discovering the frequent pattern from the target data shown in FIG. 13 in the third embodiment when the minimum pattern length is set to 4 and the minimum support count is set to 3 will be explained.

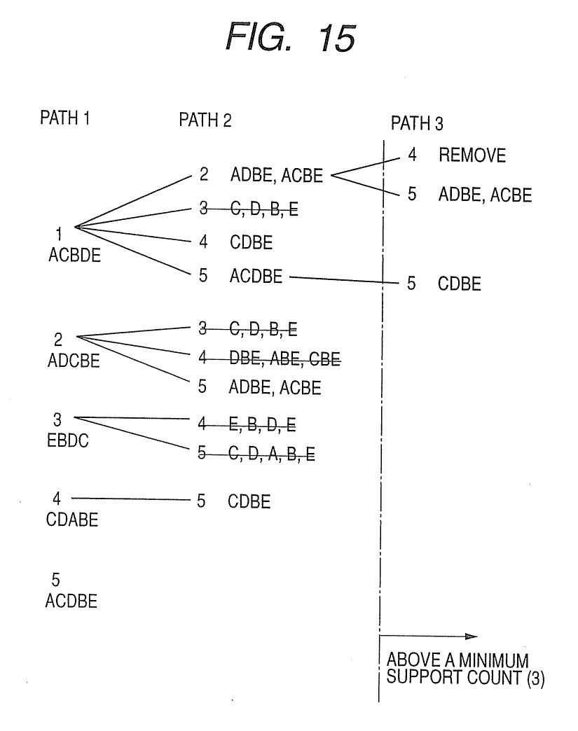

FIG. 15 is a view showing an example of a tree structure of data in the method for performing a frequent pattern mining according to the third embodiment.

The target data shown in FIG. 13 is stored in the target data storage 11 (step S1). Then, in the first path (k=1) five sets of 1, 2, 3, 4, 5 as the candidate record set with a length 1 are generated (step S2).

Then, the subset generation unit 52 generates the subsets whose record length is shorter than the candidate record set by 1 with respect to the candidate record sets respectively (step S21). Then, the subset generation unit 52 searches whether or not the subsets are stored in the candidate record set storage 54 (step S22). In the first path, the subset is an empty set and nothing is stored in the candidate record set storage 54. Therefore, assume that no candidate record set is removed.

If the candidate record set with a length k is present (step S3), the candidate item set contained in respective candidate record sets is calculated (step S4). In the first path, the candidate sequential patterns are all sequential records ACDBE, ADCBE, EBDC, CDABE, ACDBE contained in the target data.

Also, the pattern lengths of respective candidate item sets are calculated (step S5). In this case, since there exists no candidate record set that does not satisfy the minimum pattern length (3), there is no candidate record set that is to be removed in step S6. Also, in step S61, five candidate record sets of 1, 2, 3, 4, 5 are stored in the candidate record set storage 54.

In the second path (k=2), the candidate record set with a length 2 is generated from the candidate record set with a length 1 (step S2). For example, since two candidate record sets of 1 and 2 satisfy the relationship given by Formula (1), the candidate record set of 12 is generated by Formula (2). Similarly, ten sets 12, 13, 14, 15, 45 are generated as the candidate record set with a length 2 respectively by combining other candidate record sets with a length 1.

Then, the subset generation unit 52 generates the subsets whose record length is shorter than the candidate record set by 1 with respect to the candidate record sets respectively (step S21). This subset is given as two subsets of 1 and 2 to the candidate record set of 12, for example. Since both subsets of 1 and 2 are stored in the candidate record set storage 54, the candidate record set of 12 is not removed. Similarly, since nine remaining candidate record sets are not removed, ten candidate record sets remain.

If the candidate record set with a length 2 is present (step S3), the candidate sequential pattern is calculated (step S4). For example, the sequential pattern of the candidate record set of 1 is ACDBE, and the sequential pattern of the candidate record set of 2 is ADCBE. Therefore, the longest common subsequence corresponding to the candidate record set of 12 is ADBE and ACBE.

Then, the lengths of respective candidate sequential patterns are calculated with respect to the candidate record sets with a length 2 (step S5). For example, the candidate sequential pattern corresponding to the candidate record set of 12 is ADBE and ACBE, and its length is 4.

After lengths of the candidate sequential patterns are calculated with respect to all candidate record sets, the candidate record sets whose length is below a minimum pattern length (4) are removed (step S6). Here, the candidate record sets of 13, 23, 24, 34, 35 in which the length of the candidate sequential pattern is below 4 are removed. Therefore, five candidate record sets of 12, 14, 15, 25, 45 out of the candidate record sets with a length 2 remain. These candidate record sets are stored in the candidate record set storage 54 (step S61).

In the third path (k=3), the candidate record sets with a length 3 are generated from the candidate record sets with a length 2 (step S2). For example, since two candidate record sets of 12 and 14 satisfy the relation given by Formula (1), the candidate record set of 124 is generated by Formula (2). Similarly, three sets of 124, 125, 145 are generated as the candidate record sets with a length 3 respectively by combining other candidate record sets with a length 1.

Then, the subset generation unit 52 generates the subsets whose record length is shorter than the candidate record set by 1 with respect to the candidate record sets respectively (step S21). This subset is given as two sets of 12, 24 to the candidate record set of 124, for example. Since the subset of 24 out of the subsets of 12 and 24 is not stored in the candidate record set storage 54, the candidate record set of 124 is removed. As a result, two candidate record sets of 125, 145 are left.

If the candidate record set with a length 3 is present (step S3), the candidate sequential pattern is calculated (step S4). For example, the sequential pattern existing commonly in the candidate record sets of 12 is ADBE and ACBE, and the sequential pattern of the candidate record set of 25 is ADBE and ACBE. Therefore, the longest common subsequence corresponding to the candidate record set of 125 is ADBE and ACBE.

Then, lengths of respective candidate sequential patterns are calculated with respect to the candidate record set with a length 2 (step S5). For example, the candidate sequential pattern corresponding to the candidate record set of 12 is ADBE and ACBE, and its length is 4.

After lengths of the candidate sequential patterns are calculated with respect to all candidate record sets, the candidate record set whose pattern length is below the minimum pattern length is removed (step S6). Here, since there is no candidate record set in which the length of the candidate sequential pattern is below 4, two candidate record sets of 125, 145 remain. These candidate record sets are stored in the candidate record set storage 54 (step S61).

In the fourth path (k=4), the candidate record set with a length 4 is generated from the candidate record set with a length 3 (step S2). In this example, the candidate record set that is to be generated does not exist. Therefore, the processes in step S7 and step S8 are executed.

Here, since the minimum support count is set to 4, the candidate record sets whose record length is below 4 are removed (step S7). The remaining candidate record sets are two sets of 125, 145.

The longest common subsequence corresponding to these candidate record sets are ADBE, ACBE, CDBE, and the set of these candidate sequential patterns is F′. Then, F={ADBE, ACBE, CDBE} is obtained as the set F of the frequent sequential patterns by extracting all subsets whose pattern length is more than the minimum length from these candidate sequential patterns (step S8).

In this manner, in the mining process of the frequent sequential pattern in the present embodiment, not the attribute space but the record space is searched. Therefore, even when the number of attributes is increased, an explosive increase of the number of attribute combinations is never caused. As a result, the frequent sequential pattern can be found effectively from the data having the large number of attributes.

Also, the length of the longest common subsequence of the candidate record set does not become longer at all than the length of the longest common subsequence of the subsets of the candidate record set. Therefore, when the subset is not stored in the candidate record set storage in the preceding path, i.e., when the length of the longest common subsequence of the subset is below the minimum pattern length, the candidate record set corresponding to the subset is removed by the candidate generating condition deciding portion. As a result, the unnecessary operation can be suppressed and also the frequent sequence pattern can be found effectively.

### Other Embodiment

The above description is given as mere illustrations. The present invention is not limited to the above embodiments and can be implemented in various modes. The present invention can be embodied by combining features of respective embodiments. For example, the frequent pattern mining system can be realized on a single computer or can be realized by combining a plurality of computers. Also, the distributed memory type parallel computer is employed as respective calculation units, but other architecture such as the shared memory type parallel computer, the distributed shared memory type parallel computer, or the like, which is able to carry out the parallel computation, can be employed.

It is to be understood that the invention is not limited to the specific embodiment described above and that the present invention can be embodied with the components modified without departing from the spirit and scope of the present invention. The present invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. A frequent pattern mining system for discovering a frequent pattern from an target data of a set of records, each of the records containing a set of items, the frequent pattern being defined as:
a pattern of the set of items contained in the records;
a pattern including a number of the items more than a minimum pattern length; and
a pattern whose support count is larger than a minimum support count,
wherein the system comprises:
an target data storage that stores the target data;
a candidate record set generation unit that generates a candidate record set having one or more of the records contained in the target data as an element;
a candidate item set generation unit that generates a candidate item set by extracting the items that belong commonly to each of the records contained in the candidate record set;
a pattern length calculation unit that calculates a number of the items belonging to the candidate item set to obtain a pattern length of the candidate item set;
a pattern removing unit that removes the candidate record set corresponding to the candidate item set having the pattern length shorter than the minimum pattern length;
a frequent pattern generation unit that extracts all subsets, having the pattern length that is equal to or larger than the minimum pattern length, from the candidate item set, to which the candidate record set in which a number of the records is more than the minimum support count corresponds, to obtain the frequent pattern; and
a frequent pattern storage that stores the frequent pattern, and
wherein the candidate record set generation unit operates to:
(1) generate the candidate record set containing one of the records contained in the target data as the element, when the candidate record set does not exist; and
(2) generate repeatedly an union of two of the candidate record sets, in which only one of the elements is mutually different, from the candidate record set having a largest number of the records as elements, as a new candidate record set until the new candidate record set could not be generated, when the candidate record set exists.

2. The system according to claim 1 further comprising:
an attribute splitting unit that splits the target data into a plurality of target data having one or more of the items; and
a plurality of split data storages that store the target data split by the attribute splitting unit, wherein the candidate item set generation unit includes a plurality of split candidate item set generation units respectively provided for each of the split data storages, the split candidate item set generation units generating split candidate item sets by extracting the items that belong commonly to respective records contained in the candidate record set and respectively stored in the split data storages,
wherein the pattern length calculation unit includes:
a plurality of split pattern length calculation units respectively provided for each of the split data storages, the split pattern length calculation units calculating a number of items belonging to the split candidate item sets and obtain lengths of the split candidate item sets respectively; and
a plurality of pattern length synchronizing units respectively provided for each of the split data storages, the pattern length synchronizing units calculating a total sum of lengths of all of the split candidate item sets corresponding to the candidate record set and obtaining a length of the candidate item set corresponding to the candidate record set, and
wherein the frequent pattern generation unit includes a frequent pattern linking unit that calculates all sums of the split candidate item sets, to which the candidate record set in which a number of the records is equal to or larger than the minimum support count, to obtain the candidate item set.

3. The system according to claim 1, wherein the frequent pattern is defined to satisfy all of the following (a)-(c):
(a) a pattern of the set of items contained in the records;
(b) a pattern including a number of the items more than the minimum pattern length; and
(c) a pattern whose support count is larger than the minimum support count.

4. A method for performing a frequent pattern mining for discovering a frequent pattern from a target data of a set of records, each of the records containing a set of items, the frequent pattern being defined as:
a pattern of the set of items contained in the records;
a pattern including a number of the items more than a minimum pattern length; and
a pattern whose support count is larger than a minimum support count,
wherein the method comprises:
generating a candidate record set having one or more of the records contained in the target data as an element;
generating a candidate item set by extracting the items that belong commonly to each of the records contained in the candidate record set;
calculating a number of the items belonging to the candidate item set to obtain a pattern length of the candidate item set;
removing the candidate record set corresponding to the candidate item set having the pattern length shorter than the minimum pattern length; and
extracting all subsets, having the pattern length that is equal to or larger than the minimum pattern length, from the candidate item set, to which the candidate record set in which a number of the records is more than the minimum support count corresponds, to obtain the frequent pattern, and
wherein the candidate record set is generated by performing:
(1) generating the candidate record set containing one of the records contained in the target data as the element, when the candidate record set does not exist; and
(2) generating repeatedly an union of two of the candidate record sets, in which only one of the elements is mutually different, from the candidate record set having a largest number of the records as elements, as a new candidate record set until the new candidate record set could not be generated, when the candidate record set exists.

5. The method according to claim 4 further comprising splitting the target data into a plurality of target data having one or more of the items,
wherein the candidate item set is generated by performing generating split candidate item sets for each of the split target data by extracting the items that belong commonly to respective records contained in the candidate record set,
wherein the pattern length is calculated by performing:
calculating a number of items belonging to the split candidate item sets and obtain lengths of the split candidate item sets respectively for each of the split target data; and
calculating a total sum of lengths of all of the split candidate item sets corresponding to the candidate record set to obtain a length of the candidate item set corresponding to the candidate record set for each of the split target data, and
wherein the frequent pattern is generated by performing calculates all sums of the split candidate item sets, to which the candidate record set in which a number of the records is equal to or larger than the minimum support count, to obtain the candidate item set.

6. The method according to claim 4, wherein the frequent pattern is defined to satisfy all of the following (a)-(c):
(a) a pattern of the set of items contained in the records;
(b) a pattern including a number of the items more than the minimum pattern length; and
(c) a pattern whose support count is larger than the minimum support count.

7. A frequent pattern mining system for discovering a frequent sequential pattern from an target data of a set of sequential records, each of the sequential records containing a set of items arranged in series, the frequent sequential pattern being defined as:
a pattern of the set of items contained in the sequential records and arranged in an order in the particular sequential record;
a pattern including a number of the items more than a minimum pattern length; and
a pattern whose support count is larger than a minimum support count,
wherein the system comprises:
an target data storage that stores the target data;
a candidate record set generation unit that generates a candidate record set having one or more of the sequential records contained in the target data as an element;
a candidate sequential pattern generation unit that generates a candidate sequential pattern by extracting a longest sequential pattern that commonly exists in each of the sequential records contained in the candidate record set;
a pattern length calculation unit that calculates a number of the items belonging to the candidate sequential pattern to obtain a pattern length of the candidate sequential pattern;
a pattern removing unit that removes the candidate record set corresponding to the candidate sequential pattern having the pattern length shorter than the minimum pattern length;
a candidate record set storage that stores the candidate record sets that are not removed by the pattern removing unit;
a subset generation unit that generates a subset having the pattern length shorter than the candidate record set with respect to the candidate record set;
a subset searching unit that deletes the candidate record set when no subset generated with respect to the candidate record set is stored in the candidate record set storage;
a frequent pattern generation unit that extracts all subsets, having the pattern length that is equal to or larger than the minimum pattern length, from the candidate sequential patterns, to which the candidate record set in which a number of the sequential records is more than the minimum support count corresponds, to obtain the frequent sequential pattern; and
a frequent pattern storage that stores the frequent sequential pattern, and
wherein the candidate record set generation unit operates to:
(1) generate the candidate record set containing one of the sequential records contained in the target data as the element, when the candidate record set does not exist; and
(2) generate repeatedly an union of two of the candidate record sets, in which only one of the elements is mutually different, from the candidate record set having a largest number of the sequential records as elements, as a new candidate record set until the new candidate record set could not be generated, when the candidate record set exists.

8. The system according to claim 7, wherein the frequent pattern is defined to satisfy all of the following (a)-(c):
(a) a pattern of the set of items contained in the records;
(b) a pattern including a number of the items more than the minimum pattern length; and
(c) a pattern whose support count is larger than the minimum support count.

9. A method for performing a frequent pattern mining for discovering a frequent sequential pattern from an target data of a set of sequential records, each of the sequential records containing a set of items arranged in series, the frequent sequential pattern being defined as:
a pattern of the set of items contained in the sequential records and arranged in an order in the particular sequential record;
a pattern including a number of the items more than a minimum pattern length; and
a pattern whose support count is larger than a minimum support count,
wherein the method comprises:
generating a candidate record set having one or more of the sequential records contained in the target data as an element;
generating a candidate sequential pattern by extracting a longest sequential pattern that commonly exists in each of the sequential records;
calculating a number of the items belonging to the candidate sequential pattern to obtain a pattern length of the candidate sequential pattern;
removing the candidate record set corresponding to the candidate sequential pattern having the pattern length shorter than the minimum pattern length;
storing the candidate record sets that are not removed by the pattern removing unit into a candidate record set storage;
generating a subset having the pattern length shorter than the candidate record set with respect to the candidate record set;
deleting the candidate record set when no subset generated with respect to the candidate record set is stored in the candidate record set storage; and
extracting all subsets, having the pattern length that is equal to or larger than the minimum pattern length, from the candidate sequential patterns, to which the candidate record set in which a number of the sequential records is more than the minimum support count corresponds, to obtain the frequent sequential pattern, and
wherein the candidate record set is generated by performing:
(1) generating the candidate record set containing one of the sequential records contained in the target data as the element, when the candidate record set does not exist; and
(2) generating repeatedly an union of two of the candidate record sets, in which only one of the elements is mutually different, from the candidate record set having a largest number of the sequential records as elements, as a new candidate record set until the new candidate record set could not be generated, when the candidate record set exists.

10. The method according to claim 9, wherein the frequent pattern being defined to satisfy all of the following (a)-(c):
(a) a pattern of the set of items contained in the records;
(b) a pattern including a number of the items more than the minimum pattern length; and
(c) a pattern whose support count is larger than the minimum support count.
